(19) United States
(12) Patent Application Publication
(10) Pub. No.: US 2026/0158852 A1
(43) Pub. Date: Jun. 11, 2026

(54) SYSTEM AND METHOD FOR MONITORING A FILTER STATE OF A HVAC SYSTEM IN A VEHICLE

(71) Applicants: HYUNDAI MOTOR COMPANY, Seoul (KR); KIA CORPORATION, Seoul (KR)

(72) Inventors: Jong Won Kim, Hwaseong-si (KR); Seong Eun Kim, Hwaseong-si (KR); Jae Geun Jeong, Hwaseong-si (KR); Sung Hyun Moon, Hwaseong-si (KR)

(73) Assignees: HYUNDAI MOTOR COMPANY, Seoul (KR); KIA CORPORATION, Seoul (KR)

(21) Appl. No.: 19/095,766

(22) Filed: Mar. 31, 2025

(30) Foreign Application Priority Data
Dec. 9, 2024 (KR) 10-2024-0181577

(51) Int. Cl. B60H 1/00; B60H 3/06

(52) U.S. Cl. CPC B60H 1/00585; B60H 3/06; B60H 2003/0683

(57) ABSTRACT

A system for monitoring a filter state of a heating, ventilation, and air conditioning (HVAC) system includes a blower configured to suck and blow air from outside, an outside air temperature sensor to detect a temperature of air from outside sucked by the blower, an evaporator temperature sensor to detect a temperature of an evaporator, and a controller configured to control the blower, analyze and determine a state of a filter based on temperature information detected by the sensors when the outside air sucked by the blower sequentially passes through the filter and around the evaporator, and determine a filter replacement time based on the state of the filter.

### CROSS-REFERENCE TO RELATED APPLICATION

This application claims priority, under 35 U.S.C. § 119(a), to Korean Patent Application No. 10-2024-0181577 filed on Dec. 9, 2024, the entire contents of which are incorporated herein by reference.

### BACKGROUND

### (a) Technical Field

The present disclosure relates to a system and method for monitoring a filter state of a heating, ventilation and air conditioning (HVAC) system in a vehicle, which are configured to determine a filter replacement time through analysis of a filter state of the HVAC system, thereby informing of an appropriate filter replacement time.

### (b) Background Art

Vehicles are provided with a heating, ventilation and air conditioning (HVAC) system configured to adjust an indoor air temperature through selective supply of cold air and warm air in order to provide a comfortable environment to a passenger.

Such an HVAC system of a vehicle draws in outdoor (e.g., outside) air or indoor (e.g., inside) air using a blower, generates cold air or warm air, for example, by heating or cooling the outside or inside air, and supplies the cold air or warm air to an interior of the vehicle. The HVAC system supplies cold air in summer to keep the interior of the vehicle cool and supplies warm air in winter to keep the interior of the vehicle warm.

A general HVAC system of a vehicle discharges air cooled or heated through heat exchange of the air with refrigerant or coolant in an evaporator or a heater core installed in an HVAC case such that cooling or heating is carried out.

In addition, in the HVAC system, a filter is mounted in a path, through which air for cooling or heating passes, to remove foreign matter harmful to the human body, such as dust, exhaust gas, pollen, heavy metals, and the like contained in air.

Recently, generation of various environmental pollutants such as fine dust, ultrafine dust, and the like has increased. When such harmful substances are inhaled into the body, there may be a risk not only of respiratory diseases, but also other diseases.

To this end, a filter is installed and used in the HVAC system. However, when foreign matter is accumulated in the filter or when mold, and the like grow on the filter, HVAC performance may be degraded due to a reduced airflow volume, and various health problems may occur. Therefore, the filter should be replaced in order to secure desired cleanliness of indoor air of the vehicle.

In particular, as the concept of vehicle utilization changes from driving or traveling purposes to the concept of residence, cleanliness of the vehicle indoor air becomes even more important. In this regard, it is important to replace the filter at an appropriate time.

However, although technology for determining a filter replacement time through analysis of a filter state in a vehicle, thereby informing of an appropriate filter replacement time, is needed, such technology has not been applied to vehicles yet. Generally, filter replacement is intermittently carried out when vehicle maintenance or the like is performed.

For determination as to whether or not it is time to replace a filter, a state of the filter should be analyzed through acquisition and collection of information indicative of the filter state. To this end, an additional sensor or device is required. However, this may cause an increase in vehicle cost.

### SUMMARY OF THE DISCLOSURE

The present disclosure has been made in an effort to solve the above-described problems associated with the prior art. An object of the present disclosure is to provide a system and method for monitoring a filter state of a heating, ventilation and air conditioning (HVAC) system in a vehicle, which are capable of determining a filter replacement time through analysis of the filter state of the HVAC system, without using an additional sensor or device, thereby informing the driver of an appropriate filter replacement time.

The objects of the present disclosure are not limited to the above-described objects, and other objects of the present disclosure not yet described should be more clearly understood by those of ordinary skill in the art from the following detailed description. In addition, objects of the present disclosure may be accomplished by means defined in the appended claims and combinations thereof.

In one aspect, the present disclosure provides a system for monitoring a filter state of a heating, ventilation and air conditioning (HVAC) system in a vehicle, including a blower configured to suck and blow air from outside the vehicle, an outside air temperature sensor configured to detect a temperature of the air from outside the vehicle sucked by the blower, an evaporator temperature sensor configured to detect a temperature of an evaporator, and a controller. The controller is configured to control operation of the blower and to analyze and determine a state of a filter, thereby determining a filter replacement time, based on temperature information detected by the outdoor air temperature sensor and the evaporator temperature sensor, the air from outside the vehicle sucked by the blower sequentially passing through the filter and around the evaporator.

In an embodiment, the system may further include an information output device configured to output filter state information including filter replacement request information when the controller determines that a current state of the filter corresponds to the filter replacement time.

In another embodiment, the filter replacement request information may be information providing guidance on how to replace the filter, requesting filter replacement, or warning of a need for filter replacement.

In still another embodiment, the controller may be configured to perform or enter a filter checking mode, and the controller may be configured to analyze the state of the filter based on temperature information detected by the outside air temperature sensor and the evaporator temperature sensor when the controller enters the filter checking mode and operates the blower upon ignition-off of the vehicle.

In yet another embodiment, the controller may be configured to analyze the state of the filter when the controller enters the filter checking mode and operates the blower upon ignition-off of the vehicle and controls an HVAC mode to be a full outside air mode.

In yet another embodiment, the controller may be configured to enter the filter checking mode only when heating or cooling has been performed before ignition-off of the vehicle.

In yet another embodiment, the controller may be configured to operate the blower when a state of charge (SoC) of a battery of the vehicle is not less than (i.e., equal to or greater than) a predetermined SoC when the controller enters the filter checking mode.

In another further embodiment, when the controller enters the filter checking mode such that the outside air sucked by the blower sequentially passes through the filter and around the evaporator, the controller may obtain information representing the state of the filter based on an initial evaporator temperature detected by the evaporator temperature sensor when the filter checking mode is initiated, a convergence temperature that is an evaporator temperature, detected by the evaporator temperature sensor, which no longer varies after variation from the initial evaporator temperature, a convergence time taken for the evaporator temperature detected by the evaporator temperature sensor to reach the convergence temperature after varying from the initial evaporator temperature, and an outside air temperature detected by the outside temperature sensor. The controller may also be set to determine the filter replacement time based on the obtained information representing the state of the filter.

In another further embodiment, the controller may be configured to determine, as the information representing the state of the filter, a thermal time constant (τ) at a time when the evaporator temperature reaches to the convergence temperature after varying from the initial evaporator temperature under a current outside temperature condition, based on the initial evaporator temperature, the convergence temperature, the convergence time, and the outside air temperature. The controller may also be configured to determine that a current state of the filter corresponds to the filter replacement time when the thermal time constant is not less than (i.e., equal to or greater than) a predetermined value.

In yet another further embodiment, the thermal time constant may be determined based on the initial evaporation temperature, the convergence temperature, the convergence time, and the outside air temperature in accordance with Expression 1 as follows:

$$\frac{Δ Time}{In \vert [ \frac{{T}_{out} - {T}_{EVA}}{{T}_{out} - {T}_{time}} ] \vert} = τ \qquad [ Expression 1 ]$$

where, “τ” represents the thermal time constant, “Tₒᵤₜ” represents the outside air temperature, “T_{EVA}” represents the initial evaporator temperature, “Tₜᵢₘₑ” represents the convergence temperature, and “Δ_{Time}” represents the convergence time.

In another aspect, the present disclosure provides a method for monitoring a filter state of a heating, ventilation and air conditioning (HVAC) system in a vehicle, including: initiating, by a controller, a filter checking mode; operating, by the controller, a blower to suck and blow outside air when the filter checking mode has been initiated; obtaining, by the controller, temperature information through an outside air temperature sensor configured to detect a temperature of the outside air sucked by the blower and an evaporator temperature sensor configured to detect a temperature of an evaporator when the sucked outside air sequentially passes through a filter and around the evaporator; analyzing, by the controller, a state of the filter based on the obtained temperature information; and determining, by the controller, a filter replacement time based on the state of the filter.

In an embodiment, the method may further include controlling, by the controller, operation of an information output device to output filter state information including filter replacement request information, upon determining, by the controller, that a current state of the filter corresponds to the filter replacement time.

In another embodiment, the filter replacement request information may be information providing guidance on how to replace the filter, requesting filter replacement, or warning of a need for filter replacement.

In still another embodiment, the controller may be configured to analyze a state of the filter based on temperature information detected by the outside air temperature sensor and the evaporator temperature sensor when the controller enters the filter checking mode to operate the blower upon ignition-off of the vehicle.

In yet another embodiment, the controller may be configured to analyze a state of the filter when the controller enters the filter checking mode to operate the blower upon ignition-off of the vehicle and controls an HVAC mode to be a full outside air mode.

In yet another embodiment, the controller may be set to enter the filter checking mode only when heating or cooling has been performed before ignition-off of the vehicle.

In yet another embodiment, the controller may be configured to operate the blower when a state of charge (SoC) of a battery of the vehicle is not less than (i.e., equal to or greater than) a predetermined SoC when the controller enters the filter checking mode.

In another further embodiment, when the outside air sucked by the blower sequentially passes through the filter and around the evaporator, the controller may be set to obtain information representing a state of the filter based on an initial evaporator temperature detected by the evaporator temperature sensor at a filter checking mode entrance time (i.e., when the filter checking mode is initiated), a convergence temperature that is an evaporator temperature, detected by the evaporator temperature sensor, which no longer varies after variation from the initial evaporator temperature, a convergence time taken for the evaporator temperature detected by the evaporator temperature sensor to reach the convergence temperature after varying from the initial evaporator temperature, and an outside air temperature detected by the outside temperature sensor. The controller may also be configured to determine the filter replacement time based on the obtained information representing the state of the filter.

In another further embodiment, the controller may be configured to determine, as the information representing the state of the filter, a thermal time constant (τ) at a time when the evaporator temperature reaches to the convergence temperature after varying from the initial evaporator temperature under a current outside temperature condition, based on the initial evaporator temperature, the convergence temperature, the convergence time, and the outdoor air temperature. The controller may also be configured to determine that a current state of the filter corresponds to the filter replacement time when the thermal time constant is not less than (i.e., equal to or greater than) a predetermined value.

In yet another further embodiment, the thermal time constant may be determined based on the initial evaporation temperature, the convergence temperature, the convergence time, and the outside air temperature in accordance with Expression 1 as follows:

$$\frac{Δ Time}{In \vert [ \frac{{T}_{out} - {T}_{EVA}}{{T}_{out} - {T}_{time}} ] \vert} = τ \qquad [ Expression 1 ]$$

where, “τ” represents the thermal time constant, “Tₒᵤₜ” represents the outside air temperature, “T_{EVA}” represents the initial evaporator temperature, “Tₜᵢₘₑ” represents the convergence temperature, and “Δ_{Time}” represents the convergence time.

Other aspects and embodiments of the disclosure are discussed below.

The above and other features of the present disclosure are discussed below.

### BRIEF DESCRIPTION OF THE DRAWINGS

The above and other features of the present disclosure are described in detail with reference to certain example embodiments thereof illustrated in the accompanying drawings which are given hereinbelow by way of illustration only, and thus do not limit the present disclosure, and wherein:

FIG. 1 is a diagram showing main configurations of both a filter state monitoring system according to an embodiment of the present disclosure and a heating, ventilation and air conditioning (HVAC) system;

FIG. 2 is a block diagram showing the configuration of the filter state monitoring system according to an embodiment of the present disclosure;

FIG. 3 is a diagram illustrating a variation in flow rate of air passing through a filter in accordance with a state of the filter in the present disclosure;

FIG. 4 is a graph depicting an example in which an evaporator temperature converges on a specific temperature in accordance with a filter state after execution of cooling of the HVAC system in the present disclosure;

FIG. 5 is a graph depicting an example in which the evaporator temperature converges on a specific temperature in accordance with a filter state after execution of heating of the HVAC system in the present disclosure;

FIG. 6 is a flowchart showing a filter state monitoring procedure according to an embodiment of the present disclosure; and

FIG. 7 is a diagram showing several examples of a thermal time constant calculated in the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

For embodiments of the present disclosure disclosed herein, specific structural or functional descriptions are provided merely as examples to describe the embodiments of the present disclosure. The embodiments of the present disclosure can be implemented in various forms. In addition, the present disclosure should not be interpreted as being limited to the embodiments described in the present specification, and it should be understood that the present disclosure includes all changes, equivalents, or substitutions within the spirit and scope of the present disclosure.

It should be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element.

In the case where an element is “connected” or “linked” to another element, it should be understood that the element may be directly connected or linked to the other element, or another element may be present therebetween. On the contrary, in the case where an element is “directly connected” or “directly linked” to another element, it should be understood that no other element is present therebetween. Other expressions describing a relationship between constituent elements, such as “between” and “immediately between”, or “adjacent to” and “directly adjacent to”, and the like, should be construed in a similar manner.

Throughout the specification, the same reference numerals refer to the same elements. It should be noted that terms used herein are merely used to describe a specific embodiment, not to limit the present disclosure. Incidentally, unless clearly used otherwise, singular expressions include a plural meaning. In this application, the term “comprises” and/or “comprising” is intended to express the existence of the mentioned constituent element, step, operation, and/or device, and does not exclude the existence or addition of another constituent element, step, operation, and/or device. When a component, device, element, or the like of the present disclosure is described as having a purpose or performing an operation, function, or the like, the component, device, or element should be considered herein as being “configured to” meet that purpose of perform that operation or function.

The present disclosure relates to a system and method for monitoring a filter state of a heating, ventilation and air conditioning (HVAC) system in a vehicle. The system and method for monitoring a filter state are capable of determining when it is time to replace a filter through analysis of the filter state of the HVAC system, without using an additional sensor or device, thereby informing the driver of an appropriate filter replacement time.

In the present disclosure, a state of a filter is analyzed and estimated based on variations in physical quantities including a variation in flow rate of air passing through the filter and a variation in heat exchange capacity of an evaporator (EVA) according to the air flow rate variation.

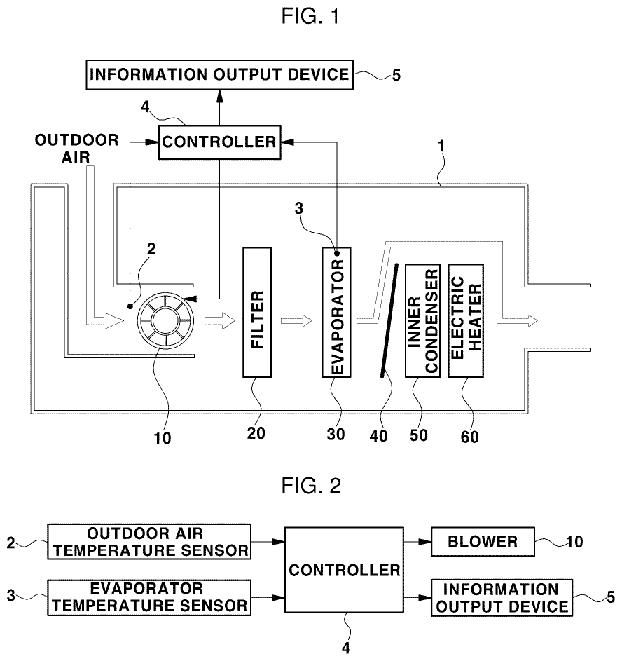

FIG. 1 is a diagram showing configurations of both a filter state monitoring system according to an embodiment of the present disclosure and an HVAC system. FIG. 2 is a block diagram showing the configuration of the filter state monitoring system according to an embodiment of the present disclosure.

The filter state monitoring system according to an embodiment of the present disclosure may include a blower 10 configured to suck outdoor or outside air and to blow the sucked air toward an evaporator 30, an outside air temperature sensor 2 configured to detect or determine a temperature of the outside air sucked by the blower 10, and an evaporator temperature sensor 3 configured to detect or determine a temperature of the evaporator 30 disposed at the side of a rear end of a filter 20.

In addition, the filter state monitoring system according to the present disclosure may further include a controller 4 configured to control operation of the blower 10 and to analyze and estimate (i.e., determine) a state of the filter 20 based on temperature information detected by the outside air temperature sensor 2 and the evaporator temperature sensor 3, thereby determining a filter replacement time.

Determination of the filter replacement time may mean determination as to whether or not filter replacement is currently required, based on the analyzed and estimated filter state (i.e., whether or not the current time is a filter replacement time).

In addition, the filter state monitoring system according to an embodiment of the present disclosure may further include an information output device 5 configured to be controlled by the controller 4. The output device 5 may be configured to output filter state information including filter replacement request information.

In one example, the filter replacement request information may be information indicating that filter replacement is currently required and providing guidance on how to replace the filter, requesting filter replacement, or warning of the need for filter replacement. In addition, the filter state information may selectively include additional information representing or indicating the analyzed and estimated filter state and information provided in association with filter replacement, in addition to the filter replacement request information.

Among the configurations of the above-described embodiment, the blower 10 is a typical vehicle HVAC blower configured to suck inside air or outside air to be supplied to an interior of the vehicle and to blow the sucked air to an HVAC case 1, for cooling and heating in the HVAC system. The filter 20, which is monitored in the present disclosure, is an HVAC filter configured to remove foreign matter contained in air supplied to the interior of the vehicle for cooling and/or heating of the vehicle interior.

In the present disclosure, information representing a state of the HVAC filter is obtained through analysis and estimation of a state of the HVAC filter. A filter replacement time is determined based on the information representing the filter state. In one example, the information representing the filter state may be a thermal time constant τ which is described hereinafter.

In the HVAC system, the filter 20 may be installed at the front end side of the blower, i.e., an upstream side of the blower 10 with reference to an air flow direction, or may be installed at the rear end side of the blower, i.e., a downstream side of the blower 10, as illustrated in FIG. 1. FIG. 1 shows an example in which the filter 20 is installed at the rear end side of the blower 10 and the front end side of the evaporator 30 with reference to the air flow direction in the HVAC system.

The outside air temperature sensor 2 is a temperature sensor configured to detect a temperature of outside air sucked by the blower 10. The outside air temperature sensor 2 is electrically connected to the controller 4. The outside air temperature sensor is configured to output an electrical signal corresponding to the outside air temperature and to input or send the electrical signal to the controller 4.

As illustrated in FIG. 1, the outside air temperature sensor 2 may be installed at the front-end side of the blower 10 (a position upstream of the blower 10) and may be installed in a passage through which the outside air sucked by the blower 10 passes.

The evaporator temperature sensor 3 is a temperature sensor installed at the evaporator 30 of the HVAC system to detect a temperature of the evaporator 30. The evaporator temperature sensor 3 is electrically connected to the controller 4 to output an electrical signal corresponding to an evaporator temperature and to input or send the electrical signal to the controller 4.

The evaporator 30 is an evaporator for a typical HVAC system configured to perform heat exchange between refrigerant and air for HVAC. The evaporator 30 is an essential constituent element of an air conditioning system for indoor (e.g., interior, inside) cooling. As such, the evaporator 30 cools air supplied to the interior of the vehicle using latent heat of refrigerant while evaporating the refrigerant expanded through an expansion valve.

Air passing around the evaporator 30 is cooled by refrigerant passing through an interior of the evaporator 30. The air cooled while passing around the evaporator 30 is supplied to the interior of the vehicle and, as such, indoor cooling is carried out.

Referring to FIG. 1, in the HVAC case 1, the evaporator 30 is disposed at an upstream position (a front-end side) with reference to an air flow direction, and an inner condenser 50, which is an auxiliary heater, and an electric heater 60, which is a main heater, are sequentially disposed at a downstream position (a rear-end side of the evaporator) with reference to the air flow direction.

The inner condenser 50 is a heat exchanger installed in the HVAC case 1 to perform heat exchange between refrigerant and air. The inner condenser 50 is connected to a refrigerant outlet of a compressor (not show) through a refrigerant line. Accordingly, refrigerant compressed to have a high temperature and a high pressure by the compressor may be supplied to the inner condenser 50 through the refrigerant line.

The refrigerant passing through the inner condenser 50 after being compressed to have a high temperature and a high pressure by the compressor exchanges heat with air blown by the blower 10 to pass around the inner condenser 50. During heat exchange, the air is heated by the high-temperature refrigerant, and the heated air is supplied to the interior of the vehicle, and, as such, indoor heating is carried out.

The electric heater 60 may be a positive temperature coefficient (PTC) heater configured to generate heat while consuming electric power of a battery. The electric heater 60 may be installed in the HVAC case 1 at a position downstream of the inner condenser 50 (at the side of a rear end of the inner condenser) with reference to the air flow direction.

In FIG. 1, reference numeral “40” designates a temperature door (a temperature control door). The temperature door 40 adjusts an amount of air passing around the evaporator 30 alone and an amount of air sequentially passing around the evaporator 30, the inner condenser 50, and the electrical heater 60.

When a signal from the outside air temperature sensor 2 and a signal from the evaporator temperature sensor 3 are input to the controller 4, the controller 4 may obtain an outside air temperature and an evaporator temperature from respective signals of the two temperature sensors, which are temperature information for determination of a filter state.

In the present disclosure, the controller 4 determines a thermal time constant τ based on the temperature information detected by the two temperature sensors, and determines a filter replacement time using the determined thermal time constant τ, as is described hereinafter.

In addition, upon determining that the filter 20 should be replaced, based on the thermal time constant τ, the controller 4 controls operation of the information output device 5 to provide filter state information including filter replacement request information to the driver.

In other words, upon determining that filter replacement is required, the controller 4 outputs a control signal for output of the filter state information. In accordance with the control signal output from the controller 4, the information output device 5 may output filter state information including information providing guidance on how to replace the filter, requesting filter replacement, or warning of the need for filter replacement, which are, filter replacement request information.

In the present disclosure, the information output device 5 may be a device provided at the vehicle to output filter state information, for example, to the driver. Any device may be used as the information output device without any limitation, so long as the device may operate in the vehicle to inform the driver of the need for filter replacement.

For example, such a device may be a warning light of a cluster configured to be turned on to warn or inform of the need for filter replacement, or may be a display device configured to display a message or other visual information of a predetermined form guiding or requesting filter replacement. Otherwise, the device may be a sound output device configured to output audible information guiding or requesting filter replacement.

Hereinafter, a filter state monitoring procedure is described in detail.

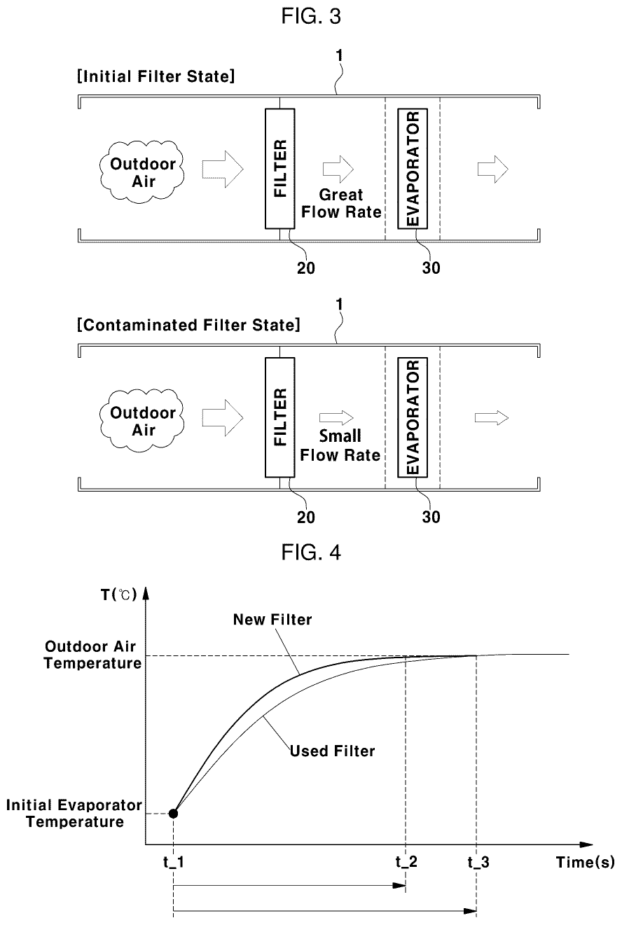

FIG. 3 is a diagram illustrating a variation in flow rate of air passing through the filter in accordance with a state of the filter in the present disclosure. In FIG. 3, the thickness of each arrow represents a flow rate level or flow rate magnitude. In other words, a thick arrow represents a relatively high flow rate, whereas a thin arrow represents a relatively low flow rate.

In an initial filter state (i.e., a new filter state), resistance at the filter 20 is small and, as such, the flow rate of air passing through the filter 20 is high, as shown in an upper figure of FIG. 3.

However, in a contaminated filter state, resistance at the filter 20 is great due to foreign matter present at the filter 20. As such, the flow rate of air passing through the filter 20 is lower than that in the initial filter state, as shown in a lower figure of FIG. 3.

FIG. 4 is a graph depicting an example in which an evaporator temperature converges on a specific temperature in accordance with a filter state after execution of cooling of the HVAC system in the present disclosure. As illustrated in FIG. 4, in the initial filter state (the new filter state) after cooling, the flow rate of air passing through the filter 20 is relatively high and, as such, the time taken for the evaporation temperature to converge on the specific temperature (=t_2−t_1) is relatively short under the condition that air emerging from the filter 20 passes around the evaporator 30.

On the other hand, in the contaminated filter state (the used filter state), the flow rate of air passing through the filter 20 is relatively low and, as such, the time taken for the evaporation temperature to converge on the specific temperature (=t_3−t_1) is longer than that of the initial filter state under the condition that air emerging from the filter 20 passes around the evaporator 30 (t_2−t_1<t_3−t_1).

In the present disclosure, convergence of the evaporator temperature means that the evaporator temperature varies gradually to a predetermined temperature, and is then maintained at the predetermined temperature without further variation. In addition, the temperature upon which the evaporation temperature converges, i.e., the predetermined temperature at which the evaporator temperature is maintained without further variation, is defined as a “convergence temperature”.

In addition, the evaporator temperature at an initial time when entrance to a filter checking mode, which is described hereinafter, is initiated, i.e., an initial temperature of the evaporator in the filter checking mode, is defined as an “initial evaporator temperature.” The time taken for the evaporator temperature varying from the initial evaporator temperature to reach a convergence temperature, which is a temperature from which the evaporator temperature varies no longer, is defined as a “convergence time”.

Although the convergence temperature is illustrated as an outsider air temperature in FIG. 4, the evaporator temperature does not always converge on the outside air temperature. When the evaporator 30 reaches a state of thermal equilibrium and, as such, has a temperature state in which the temperature of the evaporator no longer varies, it can be said that this temperature state is a convergence state of the evaporator temperature. The evaporator temperature in this convergence state is a convergence temperature.

FIG. 4 illustrates a variation in evaporation temperature in the filter checking mode after cooling. After cooling, the evaporator temperature at the initial time when entrance to the filter checking mode is initiated, i.e., an initial evaporator temperature, rises gradually and, as such, reaches a convergence temperature.

In an embodiment of the present disclosure, the thermal time constant τ may be calculated by the following Expression 1 using an outside air temperature Tₒᵤₜ, an initial evaporation temperature T_{EVA}, a convergence temperature Tₜᵢₘₑ, and a convergence time Δ_{Time}.

$$\frac{Δ Time}{In \vert [ \frac{{T}_{out} - {T}_{EVA}}{{T}_{out} - {T}_{time}} ] \vert} = τ \qquad [ Expression 1 ]$$

Where, “τ” represents a thermal time constant, “τₒᵤₜ” represents an outdoor air temperature in the filter checking mode, and “τ_{EVA}” represents an initial evaporator temperature in the filter checking mode. In the example of FIG. 4, the initial evaporator temperature T_{EVA} is an evaporator temperature at the time t_1. In addition, “τₜᵢₘₑ” represents a convergence temperature, and “Δ_{Time}” represents a convergence time.

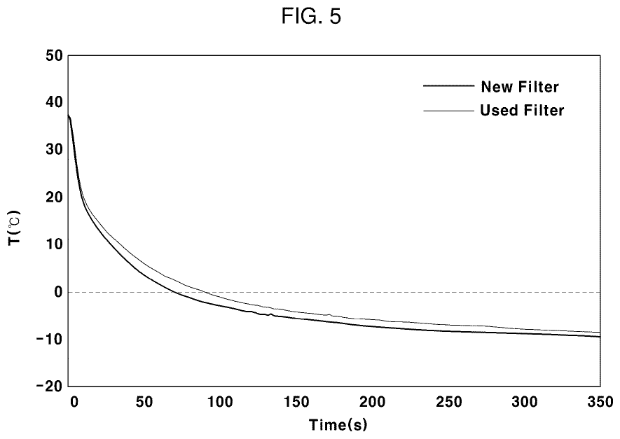

FIG. 5 is a graph depicting an example in which the evaporator temperature converges on a specific temperature in accordance with a filter state after execution of heating of the HVAC system in the present disclosure. FIG. 5 illustrates a variation in evaporator temperature in the filter checking mode after heating. After heating, oppositely to cooling, the evaporator temperature falls gradually from an initial evaporator temperature after entrance to the filter checking mode and, as such, reaches a convergence temperature.

Even after heating as described above, the convergence time taken for the evaporator temperature which varies from the initial evaporator temperature to reach the convergence temperature is longer for the used filter (a contaminated filter state) than for the new filter (an initial filter state).

As such, the flow rate of air passing through the filter 20 after cooling or heating is varied in accordance with a filter state. As a result, the time taken for the evaporator temperature to vary from the initial evaporator temperature and reach the convergence temperature, i.e., the convergence time, is varied in accordance with a filter state.

As filter contamination proceeds in the HVAC system, resistance at the filter 20 increases gradually and, as such, the flow rate of air passing through the filter 20 decreases gradually. When the flow rate of air decreases, a heat exchange capacity Q of the evaporator 30 decreases.

When the heat exchange capacity Q of the evaporator 30 decreases in a state in which outdoor air sequentially passes through the filter 20 and around the evaporator 30 as the blower 10 operates after ignition-off of the vehicle in which cooling or heating has been performed, the convergence state in which the evaporator 30 reaches a thermal equilibrium state is delayed. As a result, the convergence time taken for the evaporator temperature varying form the initial evaporator temperature to reach the convergence temperature is lengthened.

In the present disclosure, characteristics of a delay time of the thermal equilibrium of the evaporator 30 are converted into a physical quantity, i.e., a thermal time constant τ at the time when the evaporator temperature varying from the initial evaporator temperature reaches the convergence temperature under the current outdoor air temperature condition. A contaminated state of the filter 20 is determined based on the converted physical quantity. The thermal time constant τ may be understood as a value obtained by converting the heat exchange capacity Q of the evaporator 30 into a time.

The following Table 1 and Table 2 show comparison of the new filter (the initial filter state) and the used filter (the contaminated filter state) in terms of thermal time constant τ. The example of Table 2 may be an example in which filter replacement is required.

TABLE 1

| Thermal | | | | |
|---|---|---|---|---|
| Time | Outside Air | Initial Evaporator | Convergence | Convergence |
| Constant | Temperature | Temperature | Temperature | Time |
| (τ) | (Tₒᵤₜ) | (T_{EVA}) | (Tₜᵢₘₑ) | (ΔTime) |
| 186 | −20.7 | 37.8 | −8.8 | 296 |

TABLE 2

| Thermal | | | | |
|---|---|---|---|---|
| Time | Outside Air | Initial Evaporator | Convergence | Convergence |
| Constant | Temperature | Temperature | Temperature | Time |
| (τ) | (Tₒᵤₜ) | (T_{EVA}) | (Tₜᵢₘₑ) | (ΔTime) |
| 232.5 | −20.7 | 37.8 | −8.8 | 370 |

In the states of the two filters 20, the two filters 20 are equal in terms of the outside air temperature detected by the outside air temperature sensor 2, the initial evaporator temperature detected by the evaporator temperature sensor 3, and the temperature upon which the evaporator temperature detected by the evaporator temperature sensor 3 converges without further variation, i.e., the convergence temperature.

However, since the states of the two filters 20 are different from each other, the two filters 20 are different from each other in terms of the time taken for the evaporator temperature varying from the initial evaporator temperature to reach the convergence temperature, i.e., the convergence time. Accordingly, the thermal time constant τ calculated by Expression 1 varies in accordance with a filter state and, as such, increases as the filter use time increases.

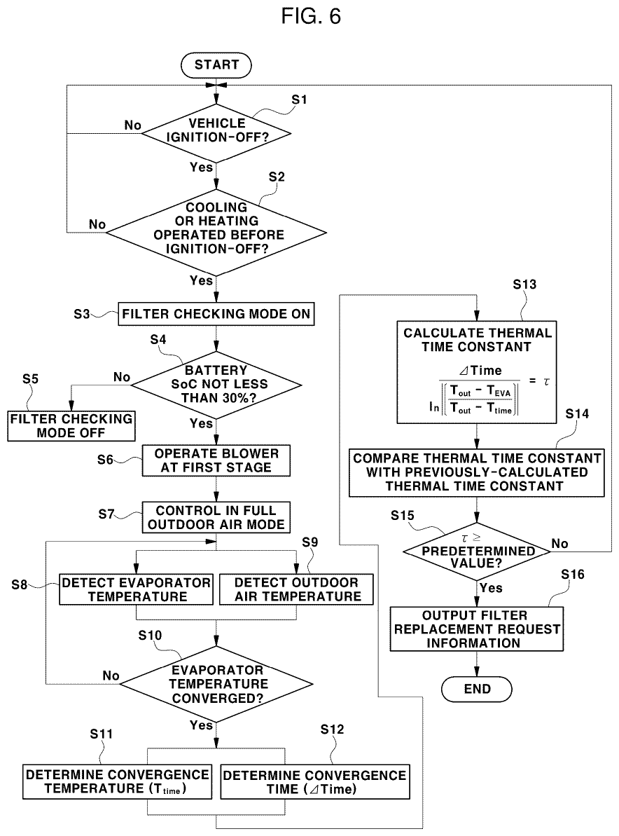

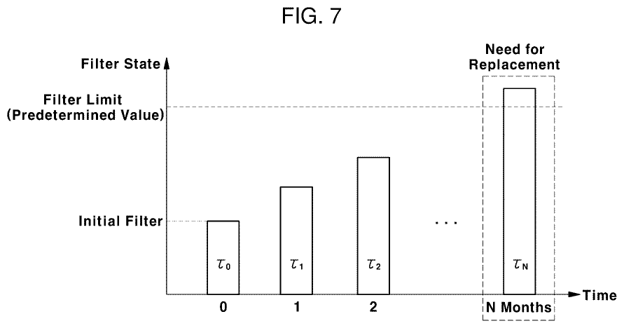

FIG. 6 is a flowchart showing a filter state monitoring procedure according to an embodiment of the present disclosure. FIG. 7 is a diagram showing several examples of a thermal time constant calculated in the present disclosure. Hereinafter, the filter state monitoring procedure is described stepwise.

In the present disclosure, the controller 4 is configured to perform a filter checking mode. The controller 4 may include a processor and memory. The memory may store one or more sets of rules or algorithms, for example, for performing the filter checking mode, and the processor may implement or execute the one or more sets of rules or algorithms. When ignition of the vehicle is turned off after a cooling or heating operation of the HVAC system (S1 and S2), the controller 4 is set or configured to enter the filter checking mode (S3).

In a state in which the controller 4 enters or is in the filter checking mode (i.e., an ON state of the filter checking mode), the controller 4 determines whether or not a state of charge (SoC) of a battery is equal to or greater than a predetermined value (for example, 30%) (S4).

When the SoC of the battery is less than the predetermined SoC, the controller 4 controls the filter checking mode to be turned off (S5). On the other hand, when the SoC is equal to or greater than the predetermined SoC, the controller 4 operates the blower 10 (S6). In this case, the controller 4 may operate the blower 10 at a first stage, and subsequently control an HVAC mode to be a full outside air mode (S7).

As described above, the controller 4 operates the blower 10 in the filter checking mode after ignition-off of the vehicle, and then controls the HVAC mode to be the full outside air mode, thereby causing outside air to sequentially pass through the filter 20 and around the evaporator 30 while being blown by the blower 10. The full outside air mode is a mode in which only outside air is sucked and blown without being mixed with indoor air.

After entrance to the filter checking mode, the controller 4 determines a thermal time constant τ at a time when an evaporator temperature detected by the evaporator temperature sensor 3 reaches a convergence temperature after varying from an initial evaporator temperature under the current outside temperature condition, based on an outside air temperature detected by the outside air temperature sensor 2 and the evaporator temperature.

In other words, after entrance to the filter checking mode, the controller 4 obtains an outside air temperature and an evaporator temperature based on signals from the outside air temperature sensor 2 and the evaporator temperature sensor 3 (S8 and S9). After entering the filter checking mode, the controller 4 also monitors whether or not the evaporator temperature converges on a specific temperature after varying from the initial evaporator temperature (S10).

When the evaporator temperature reaches a predetermined temperature after varying from the initial evaporator temperature T_{EVA} and is maintained at the predetermined temperature without further variation, the controller 4 discriminates that the evaporator temperature has converged, and determines the evaporator temperature varying no longer as a convergence temperature Tₜᵢₘₑ (S11).

In addition, the controller 4 determines, as a convergence time Δ_{Time}, the time taken for the evaporator temperature varying from the initial evaporator temperature T_{EVA} to reach the predetermined temperature, i.e., the convergence temperature Tₜᵢₘₑ (S12).

Subsequently, the controller 4 determines, as information representing or indicative of a filter state, a thermal time constant τ at a time when the evaporator temperature, varying from the initial evaporator temperature, reaches the convergence temperature (S13).

In an embodiment of the present disclosure, after the thermal time constant τ is determined, as described above, it may be possible to compare the determined thermal time constant τ with a previous thermal time constant (S14). The previous thermal time constant is a thermal time constant value calculated whenever a filter checking mode was previously operated.

After calculating a thermal time constant in an initial filter state, the controller 4 again calculates a thermal time constant when the filter checking mode is next performed, in order to again identify a filter state. Thus, the controller 4 may identify a current filter state by comparing the currently-calculated thermal time constant with a previously-calculated thermal time constant whenever the thermal time constant is calculated.

For example, the controller 4 may estimate filter replacement by identifying a thermal time constant variation state, i.e., a state in which the thermal time constant has increased. Alternatively, the controller 4 may determine generation of an error or the like in calculation of the thermal time constant by identifying, a decrease in thermal time constant or a rate at which the thermal time constant decreases. Upon determining a calculation error, the controller 4 may ignore the newly-calculated thermal time constant, and may store and maintain, as a final value, the thermal time constant calculated in the immediately preceding filter checking mode.

In addition, after determining the thermal time constant τ as information representing a filter state, through Expression 1, the controller 4 compares the determined thermal time constant with a predetermined value (S15).

Upon determining that the thermal time constant τ is equal to or greater than the predetermined value, the controller 4 determines that the filter 20 should be currently replaced, and then outputs a control signal for output of filter state information including filter replacement request information.

Accordingly, in accordance with the control signal output from the controller 4, operation of the information output device 5 is controlled to output the filter state information. In this case, filter replacement request information, i.e., information indicating that filter replacement is currently required, providing guidance on how to replace the filter, requesting filter replacement, or warning of the need for filter replacement, may be output through the information output device 5 (S16).

In addition, through the information output device 5, information as to the thermal time constant τ may be output as information representing the analyzed and estimated filter state. Additionally, other information given in association with filter replacement may be output.

Referring to FIG. 7, it can be seen that, as the filter use time increases, the thermal time constant increases gradually (τ₀<τ₁<τ₂< . . . <τₙ). When the thermal time constant τ is equal to or greater than the predetermined value, for example, a filter limit value, the controller 4 determines that filter replacement is required, and subsequently controls operation of the information output device 5 to output the filter replacement request information. Through the filter replacement request information, it may be possible to inform the driver that the current time is an appropriate time for filter replacement.

As described above, as the filter is used for a longer time, the amount of foreign matter accumulated in the filter increases gradually, resistance at the filter increases gradually, and a flow rate of air passing through the filter and a heat exchange capacity of the evaporator decrease gradually. In addition, inversely proportional to the above-described values, the time taken for the evaporator to reach thermal equilibrium and the thermal time constant τ increase gradually.

As is apparent from the above description, in accordance with the system and method for monitoring a filter state of an HVAC system in a vehicle, it may be possible to determine a filter replacement time through analysis of the filter state of the HVAC system, without using an additional sensor or device, and to inform the driver of an appropriate filter replacement time.

Accordingly, the driver may replace a filter at an appropriate time and, as such, the filter may always be maintained in good condition. As a result, cleanliness of vehicle indoor air may be maintained, and vehicle indoor comfort may be secured. In addition, a decrease in flow rate of air passing through the filter is prevented and, as such, cooling and heating performance may be maintained or enhanced.

The disclosure has been described in detail with reference to embodiments thereof. However, it should be appreciated by those of ordinary skill in the art that changes may be made to these embodiments without departing from the principles and spirit of the disclosure, the scope of which is defined in the appended claims and their equivalents.

What is claimed is:

1. A system for monitoring a filter state of a heating, ventilation and air conditioning (HVAC) system in a vehicle, the system comprising:
a blower configured to suck and blow air from outside the vehicle;
an outside air temperature sensor configured to determine a temperature of the air from outside the vehicle sucked by the blower;
an evaporator temperature sensor configured to determine a temperature of an evaporator; and
a controller configured to:
control operation of the blower;
analyze and determine a state of a filter based on temperature information determined by the outside air temperature sensor and the evaporator temperature sensor, the air from outside the vehicle sucked by the blower sequentially passing through the filter and around the evaporator; and
determine a filter replacement time based on the state of the filter.

2. The system according to claim 1, further comprising:
an information output device configured to output filter state information comprising filter replacement request information when the controller determines that a current state of the filter corresponds to the filter replacement time.

3. The system according to claim 2, wherein the filter replacement request information is information providing guidance on how to replace the filter, requesting filter replacement, or warning of a need for filter replacement.

4. The system according to claim 1, wherein:
the controller is configured to enter a filter checking mode; and
the controller is configured to analyze the state of the filter based on temperature information determined by the outside air temperature sensor and the evaporator temperature sensor when the controller enters the filter checking mode and operates the blower upon ignition-off of the vehicle.

5. The system according to claim 4, wherein the controller is configured to analyze the state of the filter when the controller enters the filter checking mode and operates the blower upon ignition-off of the vehicle and controls an HVAC mode to be a full outside air mode.

6. The system according to claim 4, wherein the controller is configured to enter the filter checking mode only when heating or cooling has been performed before ignition-off of the vehicle.

7. The system according to claim 4, wherein the controller is configured to operate the blower when a state of charge (SoC) of a battery of the vehicle satisfies a predetermined SoC when the controller enters the filter checking mode.

8. The system according to claim 4, wherein:
when the controller enters the filter checking mode such that the air from outside the vehicle sucked by the blower sequentially passes through the filter and around the evaporator, the controller obtains information representing the state of the filter based on:
an initial evaporator temperature determined by the evaporator temperature sensor when the filter checking mode is initiated;
a convergence temperature that is an evaporator temperature, determined by the evaporator temperature sensor, which no longer varies after variation from the initial evaporator temperature;
a convergence time taken for the evaporator temperature determined by the evaporator temperature sensor to reach the convergence temperature after varying from the initial evaporator temperature; and
an outside air temperature determined by the outside temperature sensor; and
the controller is configured to determine the filter replacement time based on the obtained information representing the state of the filter.

9. The system according to claim 8, wherein:
the controller is configured to determine, as the information representing the state of the filter, a thermal time constant (τ) at a time when the evaporator temperature reaches the convergence temperature after varying from the initial evaporator temperature under a current outside temperature condition, based on the initial evaporator temperature, the convergence temperature, the convergence time, and the outside air temperature; and
the controller is configured to determine that a current state of the filter corresponds to the filter replacement time when the thermal time constant satisfies a predetermined value.

10. The system according to claim 9, wherein the thermal time constant is determined based on the initial evaporation temperature, the convergence temperature, the convergence time, and the outside air temperature in accordance with Expression 1 as follows:
$$\frac{Δ Time}{In \vert [ \frac{{T}_{out} - {T}_{EVA}}{{T}_{out} - {T}_{time}} ] \vert} = τ \qquad [ Expression 1 ]$$
where, “τ” represents the thermal time constant, “Tₒᵤₜ” represents the outside air temperature, “T_{EVA}” represents the initial evaporator temperature, “Tₜᵢₘₑ” represents the convergence temperature, and “Δ_{Time}” represents the convergence time.

11. A method for monitoring a filter state of a heating, ventilation and air conditioning (HVAC) system in a vehicle, the method comprising:
initiating, by a controller, a filter checking mode;
operating, by the controller, a blower to suck and blow outside air based on the filter checking mode being initiated;
obtaining, by the controller, temperature information through an outside air temperature sensor configured to determine a temperature of the outside air sucked by the blower and an evaporator temperature sensor configured to determine a temperature of an evaporator, based on the sucked outside air sequentially passing through a filter and around the evaporator;
analyzing, by the controller, a state of the filter based on the obtained temperature information; and
determining, by the controller, a filter replacement time based on the state of the filter.

12. The method according to claim 11, further comprising:
controlling, by the controller, operation of an information output device to output filter state information comprising filter replacement request information, upon determining, by the controller, that a current state of the filter corresponds to the filter replacement time.

13. The method according to claim 12, wherein the filter replacement request information is information providing guidance on how to replace the filter, requesting filter replacement, or warning of a need for filter replacement.

14. The method according to claim 11, wherein the controller is configured to analyze the state of the filter based on temperature information determined by the outside air temperature sensor and the evaporator temperature sensor when the controller enters the filter checking mode to operate the blower upon ignition-off of the vehicle.

15. The method according to claim 14, wherein the controller is configured to analyze the state of the filter when the controller enters the filter checking mode to operate the blower upon ignition-off of the vehicle and controls an HVAC mode to be a full outside air mode.

16. The method according to claim 14, wherein the controller is configured to enter the filter checking mode only when heating or cooling has been performed before ignition-off of the vehicle.

17. The method according to claim 11, wherein the controller is configured to operate the blower when a state of charge (SoC) of a battery of the vehicle satisfies a predetermined SoC when the controller enters the filter checking mode.

18. The method according to claim 11, wherein:
when the outside air sucked by the blower sequentially passes through the filter and around the evaporator, the controller is set to obtain information representing the state of the filter based on:
an initial evaporator temperature determined by the evaporator temperature sensor when the filter checking mode is initiated;
a convergence temperature that is an evaporator temperature, determined by the evaporator temperature sensor, which no longer varies after variation from the initial evaporator temperature;
a convergence time taken for the evaporator temperature determined by the evaporator temperature sensor to reach the convergence temperature after varying from the initial evaporator temperature; and
an outside air temperature determined by the outside temperature sensor; and
the controller is configured to determine the filter replacement time based on the obtained information representing the state of the filter.

19. The method according to claim 18, wherein:
the controller is configured to determine, as the information representing the state of the filter, a thermal time constant (τ) at a time when the evaporator temperature reaches the convergence temperature after varying from the initial evaporator temperature under a current outside temperature condition, based on the initial evaporator temperature, the convergence temperature, the convergence time, and the outside air temperature; and
the controller is configured to determine that a current state of the filter corresponds to the filter replacement time when the thermal time constant satisfies a predetermined value.

20. The method according to claim 19, wherein the thermal time constant is determined based on the initial evaporation temperature, the convergence temperature, the convergence time, and the outside air temperature in accordance with Expression 1 as follows:
$$\frac{Δ Time}{In \vert [ \frac{{T}_{out} - {T}_{EVA}}{{T}_{out} - {T}_{time}} ] \vert} = τ \qquad [ Expression 1 ]$$
where, “τ” represents the thermal time constant, “Tₒᵤₜ” represents the outside air temperature, “T_{EVA}” represents the initial evaporator temperature, “Tₜᵢₘₑ” represents the convergence temperature, and “ΔTime” represents the convergence time.
